(19) United States
(12) Patent Application Publication
(10) Pub. No.: US 2007/0006746 A1
(43) Pub. Date: Jan. 11, 2007

(54) Seal with a detachable die

(75) Inventor: Chen-Yi Chen, Sijhih City (TW)

Correspondence Address: PATENTTM.US, P. O. BOX 82788, PORTLAND, OR, 97282-0788, US

(73) Assignee: Taiwan Stamp Enterprise Co., Ltd.

(21) Appl. No.: 11/179,711

(22) Filed: Jul. 11, 2005

(51) Int. Cl. B44B 5/00

(52) U.S. Cl. 101/31.1

(57) ABSTRACT

A seal may be applied to a slightly uneven surface of an article and has a base and a die. The base has a flat end surface and a resilient metal board. The resilient metal board is made of a mixture of metal and rubber or plastic and is attached evenly to the flat end surface. The die is resilient, is mounted detachably and evenly to the base and has a resilient magnetized plate. The resilient magnetized plate is made of metal particles and rubber or plastic, is attached evenly to the die and is mounted detachably and evenly to the resilient metal board on the base. The seal with the resilient metal board and magnetized plate can safely and easily seal slightly uneven surface either in a document itself or from a surface on which the document rests.

### BACKGROUND OF THE INVENTION

1. Field of the Invention

The present invention relates to a seal, and more particularly to a seal with a die that is mounted detachably on a base and can seal a slightly uneven surface of an article.

2. Description of Related Art

Seals are used generally for sealing important papers such as contracts and treaties. A conventional seal comprises a base and a die. The base is made of rigid material such as wood or marble and has two ends. The die is formed on one end of the base by carving the end of the base and has a pattern or characters. However, the rigid die can be applied merely to an even surface. When sealing on an uneven surface, parts of the pattern or characters provided by the die may be unclear and have thickness of lines different from those of other parts.

With reference to FIG. 3, another conventional seal may be applied to a slightly uneven surface and has a base (90) and a detachable die (94).

The base (90) has two ends, a mounting recess (91) and an iron plate (93). The mounting recess (91) is defined in one end of the base (90) by chiseling the end and has a bottom surface. The plate (93) is mounted securely on the bottom surface of the mounting recess (91) so that the mounting recess (91) can enclose and prevent the plate (93) from cutting a person who uses the seal.

The die (94) is made of rubber, is mounted detachably on the plate (93) in the mounting recess (91) and has an outside surface, an inside surface, an adhesive layer (95) and a magnetized rubber sheet (96). The outside surface has pattern or characters. The inside surface is coated with the adhesive layer (95). The rubber sheet (96) is attached to the adhesive layer and is mounted detachably on the iron plate (93) in the mounting recess (91) in the base (90). The resilient die (94) can accommodate slight irregularities in a surface on which a document to be stamped rests, yet the iron plate (93) provides a reinforcing base whereby the transferred image is basically authentic. However, the bottom surface of the mounting recess (91) defined by carving the die (90) may be uneven due to insufficient precision of the carving and this causes the iron plate (93) to be distorted when mounting on the bottom surface. The die (94) mounted on the distorted iron plate (93) is accordingly distorted and provides a transferred image that lacks the precise requirements necessary for legal transactions. To overcome the shortcomings, the present invention provides a seal with a detachable die to mitigate or obviate the aforementioned problems.

### SUMMARY OF THE INVENTION

The main objective of the invention is to provide a seal with a die that is mounted detachably on a base and can seal effectively despite when being used on a slightly uneven surface existing as either on a document itself or as in a hard surface beneath a document to be stamped.

A seal in accordance with the present invention may be applied to both even and uneven surfaces of articles and comprises a base and a die.

The base has a flat end surface and a resilient metal board. The resilient metal board is made of a mixture of metal particles and rubber or plastic and is attached evenly to the flat end surface.

The die is resilient, is mounted detachably and evenly to the base and has a resilient magnetized plate. The resilient magnetized plate is made of metal particles and rubber or plastic, is attached evenly to the die and is mounted detachably and evenly to the resilient metal board on the base.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a seal with a detachable die in accordance with the present invention;

FIG. 2 is an exploded perspective view of the base of a second embodiment of a seal in accordance with the present invention; and

FIG. 3 is an exploded perspective view of a conventional seal with a detachable die in accordance with the prior art.

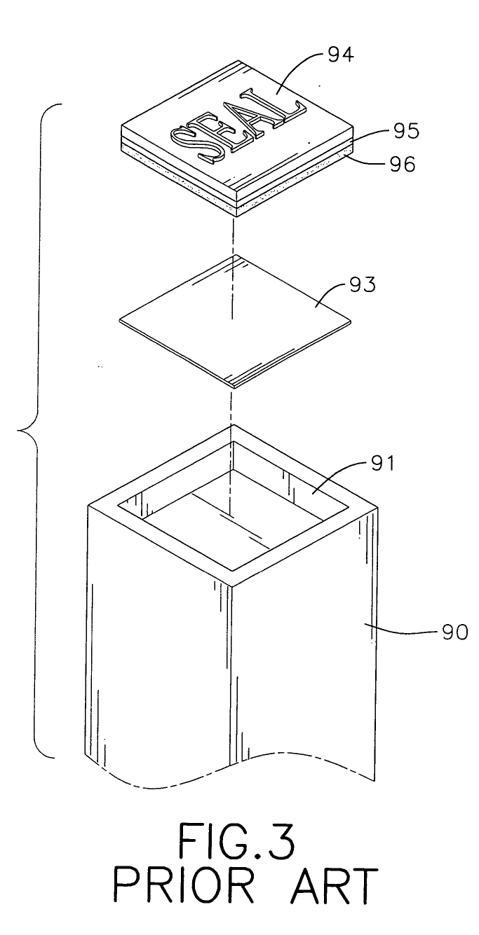

### DETAILED DESCRIPTION OF PREFERRED EMBODIMENT

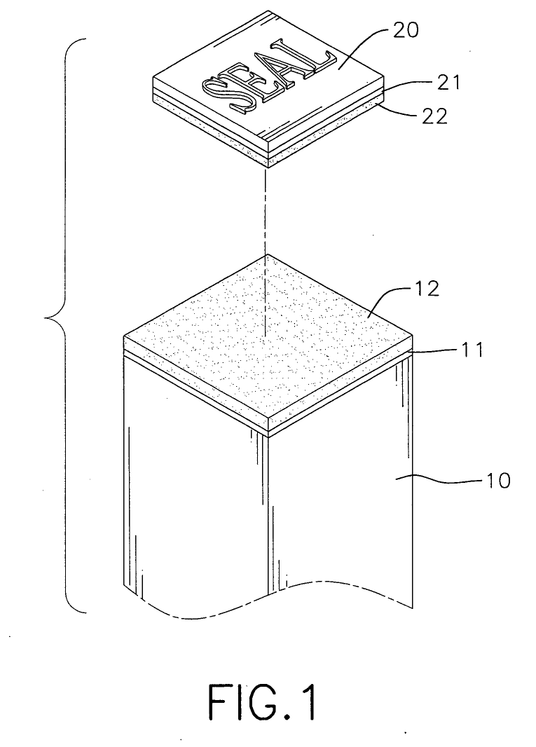

With reference to FIG. 1, a first embodiment of a seal in accordance with the present invention may be applied to a slightly uneven surface of an article such as a sheet and comprises a base (10) and a die (20).

The base (10) is made of rigid material such as wood or marble and has a flat end surface, a peripheral wall, an adhesive layer (11) and a resilient metal board (12).

The flat end surface is evenly coated with the adhesive layer (11).

The resilient metal board (12) is made of a mixture of metal particles and rubber or a mixture of such particles and plastic, and is attached evenly to the adhesive layer (11).

The die (20) is made of rubber or resilient plastic, and is mounted detachably and evenly on the resilient metal board (12). The die (20) further has an outside flat surface, an inside flat surface, an adhesive layer (21) and a resilient magnetized plate (22).

The outside flat surface has a pattern or characters. The inked pattern or characters on the resilient die (20) may be applied to a slightly uneven surface by fitting the outside flat surface of the resilient die (20) to the uneven surface.

The inside flat surface of the die (20) is coated with the adhesive layer (21).

The resilient magnetized plate (22) is made of a mixture of magnetic iron particles such as filings and rubber or a mixture of such particles and plastic, is attached evenly to the adhesive layer (21) on the die (20) and is mounted detachably to the resilient metal board (12).

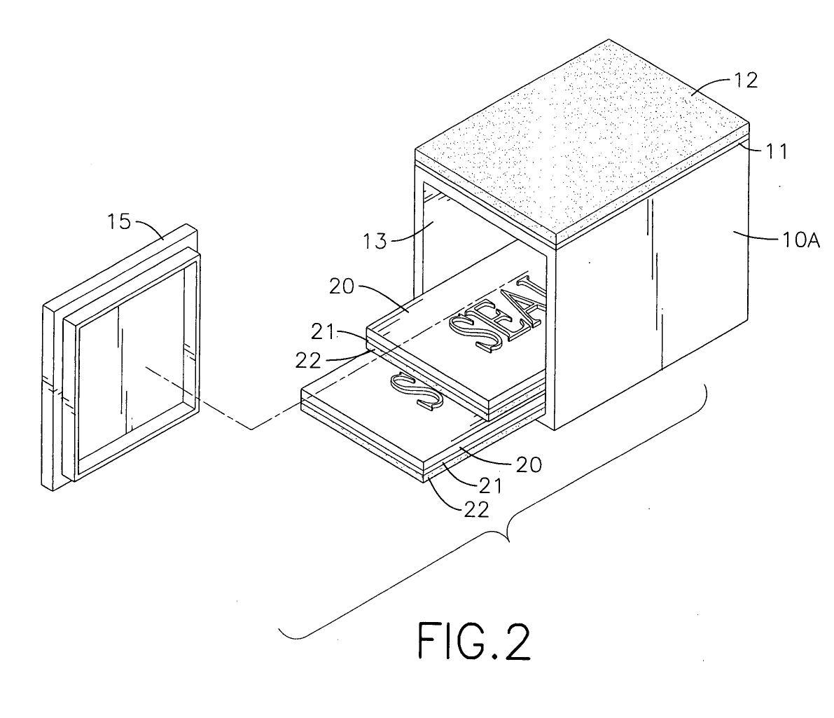

With further reference to FIG. 2, a second embodiment of the seal in accordance with the present invention is similar to the first embodiment and has a base (10A) further having a die cavity (13) and a cap (15).

The die cavity (13) is defined by the peripheral wall of the base (10A), may receive multiple dies (20) and has an opening.

The cap (15) is mounted detachably on the opening and covers the die cavity (13).

The seal with the resilient metal board (12) and resilient magnetized plate (22) can be safely used without injuring a person who uses it. Furthermore, the flat end surface can be simply made by a general cutting process so that the resilient die (20) can be easily mounted evenly to the base (10) and provide a fine pattern or characters with clear lines and uniform thicknesses of the lines to even a slightly irregular surface.

A further advantage of the present invention is that the seal can contain several dies inside the same base, thereby increasing the versatility of the seal. In particular, many seals are cut from single pieces of material such as jade, which is wasteful. That is, the die will eventually wear and be useless but in the present invention, only the die needs to be replaced, and in fact, one base replaces several integral dies. This is cost-effective, convenient, and environmentally friendly.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A seal comprising:
a base made of rigid material and having
a flat end surface;
a peripheral wall;
an adhesive layer coated evenly on the flat end surface; and
a resilient metal board attached evenly to the adhesive layer; and
a die being resilient, mounted detachably and evenly on the resilient metal board on the base and having
an outside flat surface having a pattern;
an inside flat surface;
an adhesive layer coated evenly on the inside flat surface of the die; and
a resilient magnetized plate attached evenly to the adhesive layer on the die and mounted detachably to the resilient metal board.

2. The seal as claimed in claim 1, wherein the die is made of rubber.

3. The seal as claimed in claim 1, wherein the die is made of plastic.

4. The seal as claimed in claim 1, wherein the resilient metal board is made of a mixture of metal particles and rubber.

5. The seal as claimed in claim 1, wherein the resilient metal board is made of a mixture of metal particles and plastic.

6. The seal as claimed in claim 1, wherein the resilient magnetized plate is made of a mixture of magnetic particles and rubber.

7. The seal as claimed in claim 1, wherein the resilient magnetized plate is made of a mixture of magnetic particles and plastic.

8. The seal as claimed in claim 1, wherein the base further has
a die cavity defined in the base and having an opening; and
a cap mounted detachably on the opening and covering the die cavity.
